(19) United States
(12) Patent Application Publication
(10) Pub. No.: US 2014/0115542 A1
(43) Pub. Date: Apr. 24, 2014

(54) REMOTELY CONTROLLABLE ELECTRONIC DEVICE ALLOWING A USER TO ASSOCIATE TWO MENU ITEMS WITH A CONTROL SIGNAL

(71) Applicant: Hon Hai Precision Industry Co., Ltd., New Taipei (TW)

(72) Inventor: HO-LEUNG CHEUNG, Santa Clara, CA (US)

(73) Assignee: Hon Hai Precision Industry Co., Ltd., New Taipei (TW)

(21) Appl. No.: 14/011,711

(22) Filed: Aug. 27, 2013

(30) Foreign Application Priority Data
Oct. 19, 2012 (TW) 101138557

(51) Int. Cl. G06F 3/0482

(52) U.S. Cl. CPC G06F 3/0482
USPC 715/841

(57) ABSTRACT

A system including a remote control device and an electronic device is disclosed. The electronic device provides a user interface that includes a first level menu and a second level menu. The first level menu includes several first level menu items, and the second level menu includes several second level menu items. The electronic device includes an associating module to associate one of the first level menu items and one of the second level menu items that are selected through the remote control device, with a control signal from the remote control device. A user can move a selection box between two associated menu items through the remote control device.

### BACKGROUND

1. Technical Field

The present disclosure relates to remotely controllable electronic devices, and particular to an electronic device allowing a user to associate two menu items with a control signal form a remote controller, such that the user can quickly move a selection box between the two menu items.

2. Description of Related Art

Many remotely controllable electronic devices, such as digital televisions, provide users with interactive user interface including many menu items. For some of the electronic devices, a user needs to press selection buttons of a remote controller several times to move a selection box from one menu item to a target menu item. Thus, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram view of a system including an electronic device and a remote control device according to one embodiment.

FIG. 2 is a schematic diagram view of a user interface provided by the electronic device of FIG. 1.

FIG. 3 is a schematic diagram view of showing a system including the electronic device of FIG. 1 and a remote control device of a first implementation.

FIG. 4 is a schematic diagram view of showing a system including the electronic device of FIG. 1 and a remote control device of a second implementation.

FIG. 5 is a schematic diagram view of showing a system including an electronic device of another implementation and the remote control device of FIG. 4.

FIG. 6 shows the user interface of FIG. 2 in an advanced mode.

### DETAILED DESCRIPTION

Embodiments of the present disclosure will be described with reference to the accompanying drawings.

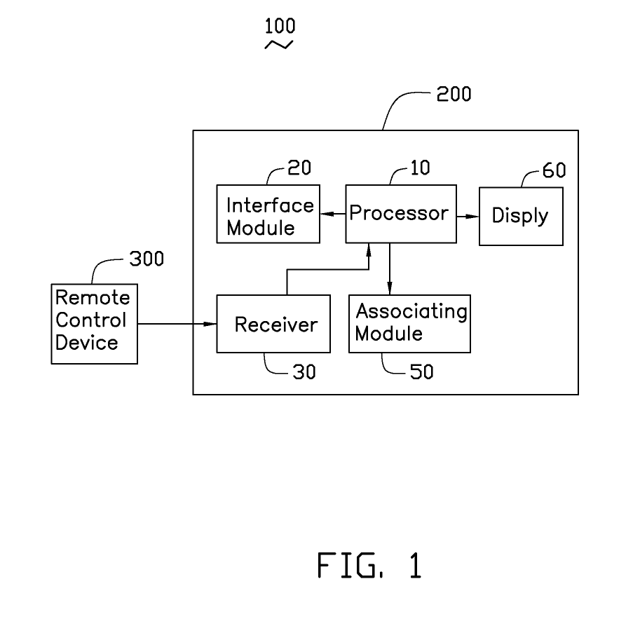

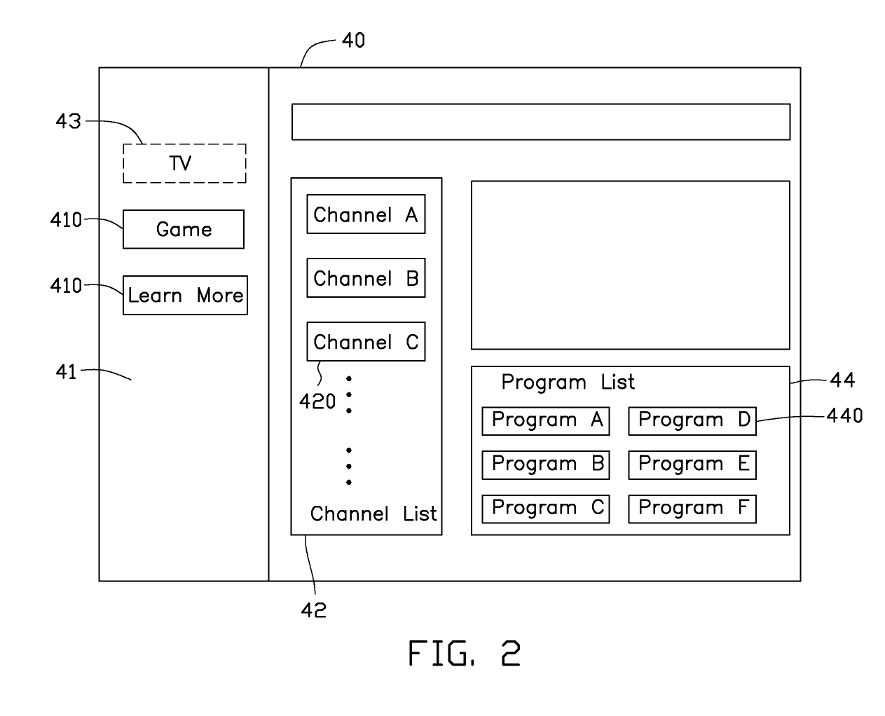

Referring to FIGS. 1 and 2, a system 100 includes an electronic device 200 and a remote control device 300. The electronic device 200 includes a processor 10, an interface module 20, a receiver 30, and a display 60. The interface module 20 is executable by the processor 10 and provides a user interface 40 that includes a first level menu 41. The first level menu 41 includes a number of first level menu items 410. When one of the menu items 410 is selected via the remote control device 300, a submenu 42 corresponding to the selected menu item 410 appears. Similarly, the submenu 42 includes a number of menu items 420. When one of the menu items 420 is selected, a submenu 44 corresponding to the selected menu item 420 appears. The submenu 44 includes a number of menu items 440.

In the embodiment, a user can select one of the menu items 410, 420, and 440 by moving a selection box 43 via the remote control device 300. For example, as shown in FIG. 2, when the selection box 43 is controlled to move to one of the menu items 410 (e.g., “TV”), the menu item 410 (“TV”) is selected. The submenu 42 including menu items 420 (e.g., channels A, B, and C) appears. When the selection box 43 is controlled to move from one of the menu items 410 to one of the menu items 420, the one of the menu items 420 is selected. The submenu 44 including menu items 440 (e.g., programs A, B, and C) appears. Similarly, the selection box 43 can be controlled to move from one of the menu items 420 to one of the menu items 440. The selection box 43 can also be controlled to move from one of the menu items 440 back to the menu item 410 (“TV”).

In the embodiment, the electronic device 200 further includes an associating module 50 that is executable by the processor 10. The associating module 50 is used to associate a selected one of the menu items 410 (e.g., “TV”) and a selected one of the menu items 440 (e.g., “program F”) with a control signal from the remote control device 300. When the selection box 43 is located on the one of the menu items 410 (e.g., “TV”) and the receiver 30 receives the control signal associated with the one of the menu items 410 (e.g., “TV”), the processor 10 controls the selection box 43 to move directly from the one of the menu items 410 (e.g., “TV”) to the one of the menu items 440 (e.g., “program F”). The one of the menu items 440 (e.g., “program F”) is thus selected. Similarly, when the selection box 43 is located on the one of the menu items 440 (e.g., “program F”) and the receiver 30 receives the control signal associated with the one of the menu items 440 (e.g., “program F”), the processor 10 controls the selection box 43 to move directly from the one of the menu items 440 (e.g., “program F”) to the one of the menu items 410 (e.g., “TV”).

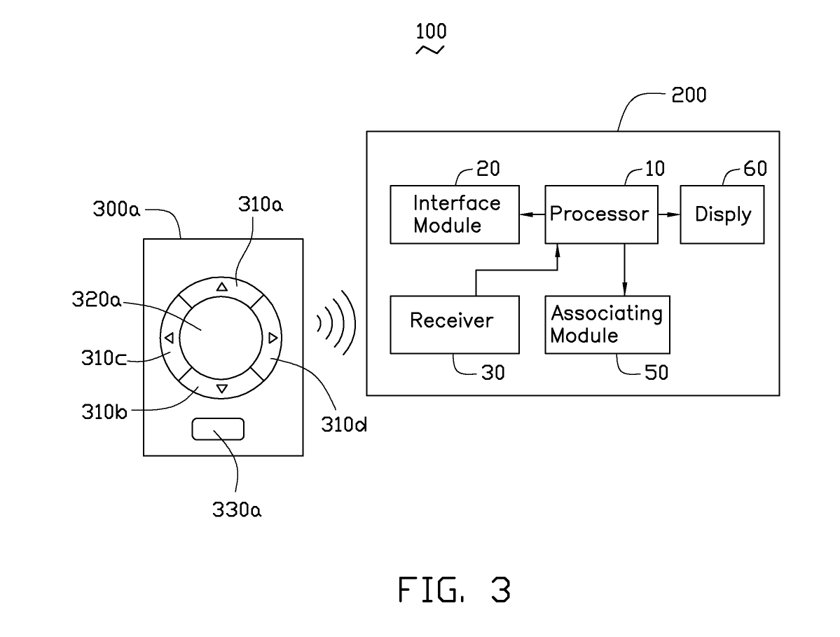

Referring to FIG. 3, in one embodiment, the remote control device 300 is a remote controller (hereinafter referred to as remote controller 300a). The remote controller 300a includes an up direction key 310a, a down direction key 310b, a left direction key 310c, a right direction key 310d, an enter key 320a, and a setting key 330a. The up direction key 310a is used to move the selection box 43 upward, and the down direction key 310b is used to move the selection box 43 downward. The left direction key 310c is used to move the selection box 43 to the left, and the right direction key 310d is used to move the selection box 43 to the right. A use can move the direction box 43 from one of the menu items 410 (e.g., “TV”) to one of the menu items 440 (e.g., “program F”) by pressing the keys 310a, 310b, 310c, and 310d several times. A user can select one menu item by pressing the enter key 320a.

When the setting key 330a is pressed, the processor 10 executes the interface module 20 and the associating module 50. The associating module 50 outputs information on the display 60 to prompt a user to select two menu items (e.g., “TV” and “program F”) and press a numeric key. The associating module 50 then associates the selected two menu items (e.g., “TV” and “program F”) with the control signal corresponding to the pressed numeric key.

In the embodiment, the user interface 40 further includes a “learn more” menu item. When the “learn more” menu item is selected, a submenu appears. The submenu includes a number of menu items. When any one of the menu items is selected, a popup window appears for providing information as to the description of a specific function of the electronic device 200.

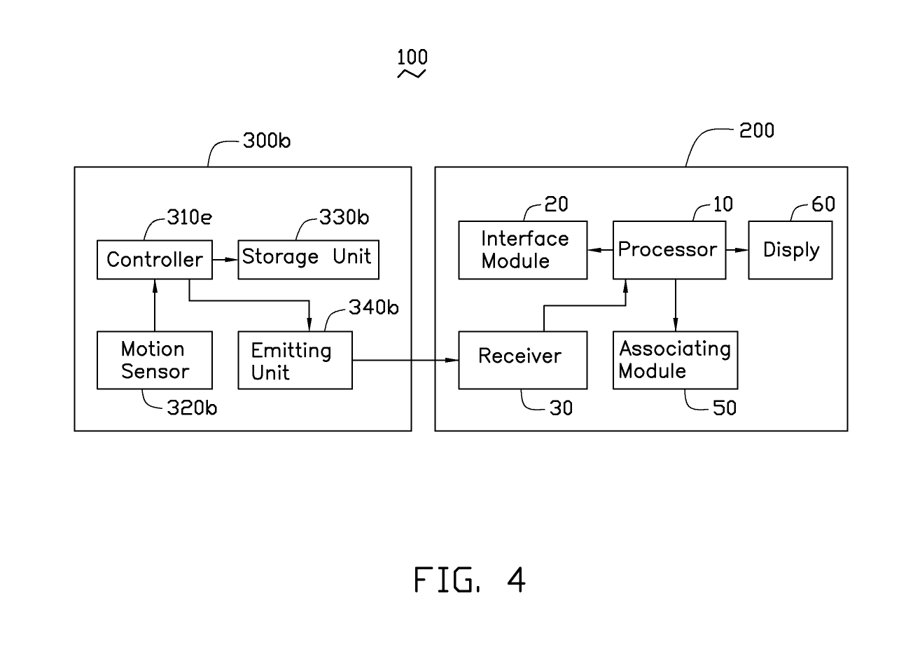

Referring to FIG. 4, in one embodiment, the remote control device 300 may be a cell phone (hereinafter referred to as cell phone 300b). The cell phone 300b includes a controller 310e, a motion sensor 320b, a storage unit 330b, and an emitting unit 340. The motion sensor 320b is used to detect a motion of the cell phone 300b. The storage unit 300b stores remote control codes corresponding to physical keys and virtual keys of the cell phone 300b. When a physical key or a virtual key is pressed, the controller 310e selects the corresponding remote control code and drives the emitting unit 340 to emit infrared rays carrying the remote control code to the electronic device 200, allowing a user to control the movement of the selection box 43. In other embodiments, a WiFi module or a Bluetooth module may be used to send signals carrying the remote control code.

In one embodiment, when the motion sensor 320b is an acceleration sensor that can obtain data reflecting the acceleration of the cell phone 300b. A motion of the cell phone 300b can be determined based on the data obtained by the motion sensor 320b. In this case, some of the remote control codes are associated with motions of the cell phone 300b. For example, a motion of rotating the cell phone 300b 90 degrees can be associated with one remote control code. When it is determined that the cell phone 300b has been rotated 90 degrees, the controller 310e selects the corresponding remote control code and drives the emitting unit 340 to emit infrared rays carrying the remote control code. Therefore, similar to those described above in relation to remote controller 300a, a user can move the selection box 43 between two associated menu items by moving the cell phone 300b to match a pre-defined motion, such as rotating the cell phone 300b 90 degrees.

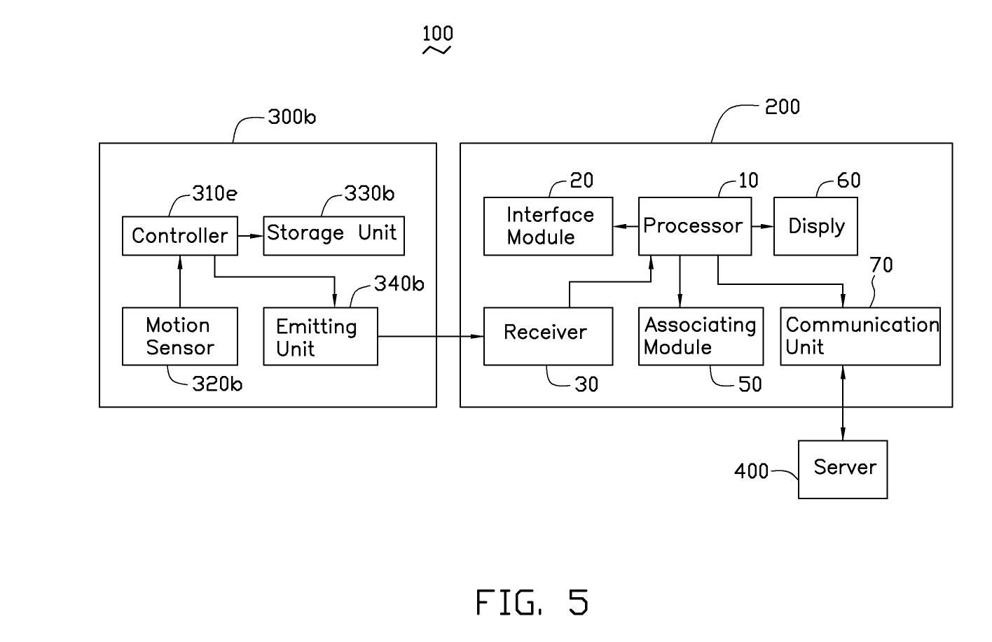

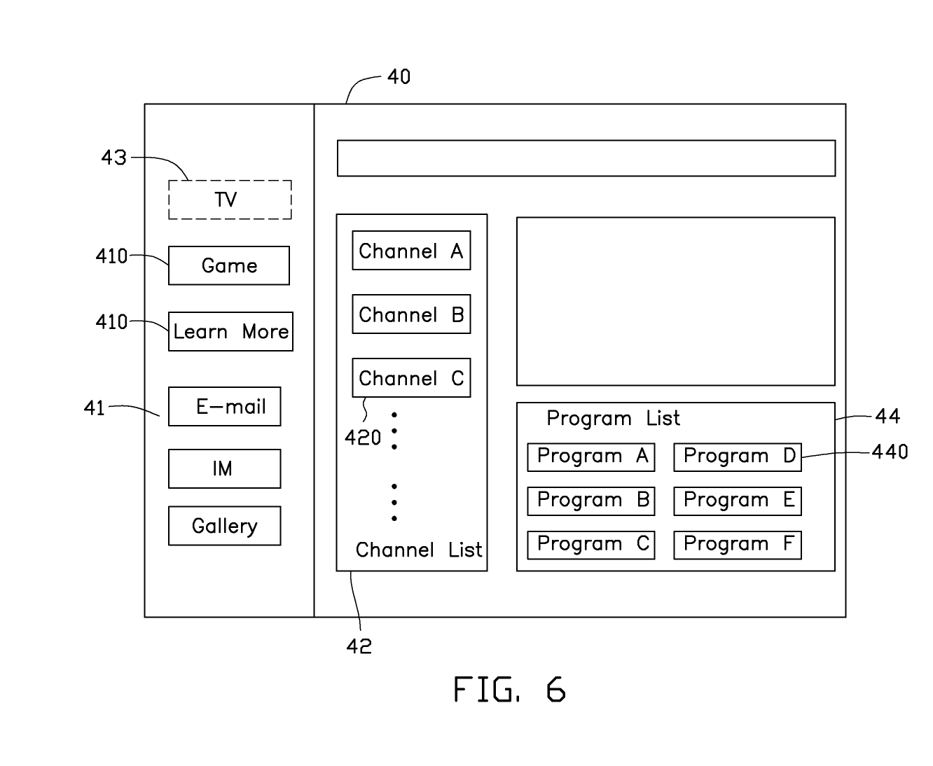

Referring to FIGS. 5 and 6, in one embodiment, the electronic device 200 may further include a communication unit 70 that can communicate with a server 400. When the motion of the cell phone 300b matches a pre-defined motion, such as rotating the cell phone 300b 90 degrees, the processor 10 causes a login box to be displayed on the display 60. A user can enter a username and a password in the login box. The username and the password are transmitted to the server 400. If the username and the password are correct, the server 400 sends a feedback to the electronic device 200. The processor 10 causes the user interface 40 to be displayed on the display 60 in an advanced mode (FIG. 6), in which selectable menu items “E-mail”, “IM”, and “Gallery” are added to the user interface 40. When the menu item “E-mail” is selected, the user is allowed to access data associated with the username stored on the server 400. Similarly, when the menu item “Gallery” is selected, the user is allowed to access photos associated with the username stored on the server 400. When the menu item “IM” is selected, the user is allowed to access instant message data associated with the username stored on the server 400.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A remotely controllable electronic device comprising:
a processor;
an interface module executable by the processor and configured to provide a user interface, the user interface comprising a first level menu and a second level menu, the first level menu comprising one or more first level menu items, and the second level menu comprising one or more second level menu items;
a receiver configured to receive control signals from a remote control device; and
an associating module executable by the processor and configured to associate one of the first level menu items and one of the second level menu items that are selected through the remote control device, with a control signal from the remote control device;
wherein when a selection box is located on the one of the first level menu items and the receiver receives the control signal that is associated with the one of the first level menu items and the one of the second level menu items, the processor moves the selection box from the one of the first level menu items to the one of the second level menu items.

2. The remotely controllable electronic device according to claim 1, wherein when a selection box is located on the one of the second level menu items and the receiver receives the control signal that is associated with the one of the second level menu items and the one of the first level menu items, the processor moves the selection box from the one of the second level menu items to the one of the first level menu items.

3. A system comprising:
a remote control device; and
an electronic device comprising:
a processor;
an interface module executable by the processor and configured to provide a user interface, the user interface comprising a first level menu and a second level menu, the first level menu comprising one or more first level menu items, and the second level menu comprising one or more second level menu items;
a receiver configured to receive control signals from a remote control device; and
an associating module executable by the processor and configured to associate one of the first level menu items and one of the second level menu items that are selected through the remote control device, with a control signal from the remote control device;
wherein when a selection box is located on the one of the first level menu items and the receiver receives the control signal that is associated with the one of the first level menu items with the one of the second level menu items, the processor moves the selection box from the one of the first level menu items to the one of the second level menu items.

4. The system according to claim 3, wherein when a selection box is located on the one of the second level menu items and the receiver receives the control signal that is associated with the one of the second level menu items and the one of the first level menu items, the processor moves the selection box from the one of the second level menu items to the one of the first level menu items.

5. The system according to claim 3, wherein the remote control device comprises a controller, a motion sensor, a storage unit, and an emitting unit, the motion sensor is configured to detect a motion of the cell phone, the storage unit is configured to store remote control codes, when a physical key or a virtual key is pressed, the controller selects a remote control code corresponding thereto and drives the emitting unit to emit infrared rays carrying the remote control code to the electronic device.

6. The system according to claim 3, wherein the motion sensor is an acceleration sensor.
